(19) United States
(12) Patent Application Publication
(10) Pub. No.: US 2001/0006596 A1
(43) Pub. Date: Jul. 5, 2001

(54) Mobile lift and storage apparatus

(76) Inventor: Coleman W. Vickary, Central Bridge, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 09/790,348

(22) Filed: Feb. 21, 2001

Related U.S. Application Data
(63) Continuation-in-part of application No. 09/414,240, filed on Oct. 7, 1999, now abandoned.
Application No. 09/414,240 is a continuation of application No. 09/257,559, filed on Feb. 25, 1999, now Pat. No. 5,993,136.

(51) Int. Cl. B66C 23/36

(52) U.S. Cl. 414/543; 414/626; 414/673

(57) ABSTRACT

A mobile lift and storage apparatus for lifting, lowering, moving, and storing objects. A combination of the mobile lift and a stationary storage apparatus forming a stationary storage system for securing the mobile lift and the stored objects.

This application is a continuation-in-part of application Ser. No. 09/414,240 with a filing date of Oct. 7, 1999 which is a continuation of application Ser. No. 09/257,559 filed on Feb. 25, 1999 now issued U.S. Pat. No. 5,993,136.

### FIELD OF THE INVENTION

The present invention relates generally to lifting and storage devices, and more particularly relates to a mobile lift and a stationary storage apparatus for lifting and storing objects such as liquid petroleum gas cylinders.

### BACKGROUND OF THE INVENTION

Mobile lifts are well known in the art. The mobile is lift allows an operator to lift a heavy object safely without causing back injuries. Also, the mobile lift can assist the operator in lifting loads heavier than the operator can physically lift without assistance. Storage racks and shelves are well known in the art for storing objects.

Mobile lifts typically include a boom pivotally mounted on a support structure. Commonly, the support structure is mounted on wheels for allowing the mobile lift to be easily moved. Many mobile lifts typically include a lift cable passing over the end of the boom. A first end of the lift cable is attached to the object to being lifted, and a second end of the lift cable is attached to a winch or to a counterweight apparatus. The counterweight can be adjusted to be essentially about the same weight as the weight of the object being lifted. Since the weight being lifted is essentially counterbalanced by the counterweight, the operator can easily lift the object, because the operator is only lifting a small portion of the total weight of the object. When the object weight changes, the operator is required to lift and to remove or add different counterweights. This lifting of the counterweights can cause back injuries to the operator.

Many fork lift trucks are powered by engines that are fueled by liquid petroleum (LP) gas or propane. The gas is typically stored in a container commonly referred to as a “cylinder.” The cylinders are removably attached to a platform on one end of the fork lift truck. Commonly, the cylinders are located four or more feet above the ground. When empty, an LP tank must be manually lowered from the fork lift truck platform to the floor. Next, a filled cylinder must be manually lifted to the fork lift truck platform.

Additionally, the empty and full cylinders must be carried to and from a central storage rack where the cylinders are safely stored. Since each filled cylinder weighs between about 60 and 80 pounds, there is a risk of injury to the operator when lifting and moving the cylinder. Furthermore, some operators may not be physically strong enough to lift and move the cylinder.

### SUMMARY OF THE INVENTION

The present invention provides a mobile lift for lifting, lowering, and moving objects. Additionally, the mobile lift combines with a stationary storage apparatus to provide a secure stationary storage system. The stationary storage system provides secure tamper resistant storage for objects and for the mobile lift. In a preferred embodiment of the present invention, the mobile lift transports, lifts, and lowers cylinders. Furthermore, the mobile lift combines with a stationary storage apparatus to provide a safe and secure stationary storage system for both the cylinders and for the mobile lift.

The mobile lift includes a main body, a boom apparatus, a counterweight apparatus, wheel assemblies, a lift cable, and a tong apparatus. Included in the main body is a tower assembly including a main wall. The main wall includes a fence that provides a removable wall for the storage apparatus. A push handle and the boom apparatus are attached to the tower assembly.

The counterweight apparatus includes two vertical guides, a pivot post, a counterweight support, a counterweight carrier, and a plurality of counterweights. Each counterweight has a centrally located hole. Counterweights are stacked and stored with the pivot post passing through the hole in each counterweight. The total weight attached to a second end of the lift cable is determined by adding the counterweight carrier weight to the combined weight of the individual counterweights that are supported by the counterweight carrier.

The counterweight carrier moves in a vertical direction and rides in the vertical guides included in the tower assembly. The counterweights are supported on hooks located in a bottom portion of the counterweight carrier. In order to obtain a desired total counterweight, the operator can select one or more counterweights to be lifted by the hooks. Each counterweight is selected for lifting by rotating the counterweight in a predetermined (e.g., clockwise) direction. Each counterweight can be rotated in an opposite (e.g., counter-clockwise) direction to deselect the counterweight for lifting. The selection process is accomplished in the lower section of the guides where there are openings to allow the counterweights to be rotated. Therefore, in the present invention, the operator engages counterweights by rotation and never has to lift the counterweights. This prevents back injuries and allows operators that are not physically strong to handle the counterweights. The combined weight of the counterweight carrier and the selected counterweights are preferably about the same weight of the cylinder being lifted. Individually selected counterweights provide weight compensation for a full, empty, or partially full cylinder.

The tong apparatus includes a tong main body and hook arms. The tong main body includes a guidance handle and a loop for attachment to a first end of the lift cable. The guidance handle is grasped by the operator and is used to lift, lower and rotate the cylinder into the desired location. Two hook arms are pivotally attached to the tong main body. The tong main body includes a plurality of holes to enable the pivot locations for the hook arms to be moved in order to accommodate different cylinder lengths. Each hook arm includes a control handle and a cylinder hook. The hook arms pivot in an inward direction to engage the ends of the cylinder with the cylinder hooks. When the operator lifts the cylinder using the guidance handle, the counterweight apparatus attached to the second end of the lift cable counterbalances the weight of the cylinder. Empty cylinders commonly weigh between about 27 to 35 pounds, and full cylinders commonly weigh between about 60 to 80 pounds. Counterweights are selected to counterbalance all but about 10 pounds of the total weight of the cylinder. For stability and control, this ensures that the cylinder, if left unattended, will always safely return to the ground. At the same time, the operator only has to provide a minimal amount of force to lift the cylinder. The operator releases the cylinder hooks from engagement with the cylinder by lifting each control handle in an upward direction.

The boom apparatus is attached to the tower assembly of the main body. The boom apparatus includes a boom arm, a pivot support assembly, a first sheave, a second sheave, a support plate, and a wheel assembly. The boom arm can be rotated 360 degrees about the pivot support assembly and is further supported by a wheel assembly including a boom support wheel that contacts the support plate. The lift cable passes over the first and second sheave, and passes through a central hole in the pivot support assembly.

A plurality of cradles attached to a main frame of the mobile lift provides storage for full and empty cylinders. In accordance with the present invention, the operator rotates the boom into a position over the cylinder to be lifted. The operator rotates the required counterweights for engagement with the hooks of the counterweight carrier. The selected counterweights counterbalance the weight of the cylinder. Next, the operator engages the cylinder hooks of the tong apparatus onto each end of the cylinder. By grasping the guidance handle of the tong apparatus, the operator lifts, moves, and lowers the cylinder to cradles attached on the main frame. Next, the operator grasps the push handle attached to the mobile lift and moves the mobile lift to a location where the cylinder is required. Wheel assemblies including pivotally mounted wheels are attached to the main frame to facilitate the movement of the mobile lift. A foot brake assembly is attached to one end of the main frame. The operator can use the foot brake assembly to hold the mobile lift in a fixed location.

If the operator is replacing an empty cylinder on a fork lift truck, the operator engages the cylinder hooks of the tong apparatus onto each end of the empty cylinder on the fork lift truck. The operator grasps the guidance handle of the tong apparatus and lifts, moves, and lowers the empty cylinder to empty cradles on the main frame. The swiveling boom allows the operator to easily move the empty cylinder from a location above the fork lift truck to a location above the empty cradles on the main frame. Next, the operator reverses the process and uses the mobile lift to lift and move a full cylinder from the cradles on the main frame to the platform on the fork lift truck.

The operator then rolls the mobile lift to a stationary storage apparatus. The stationary storage apparatus provides a secure location where empty and full cylinders can be stored. The stationary storage apparatus includes a plurality of racks with a plurality of cradles to support and receive the cylinders. The racks, cradles, and cylinders are located inside of a housing of the stationary storage apparatus. The housing includes a single opening for receiving a portion of the mobile lift. The operator uses the mobile lift to move cylinders to and from the mobile lift and the stationary storage apparatus.

Included in the tower assembly of the main body of the mobile lift is a main wall that includes a fence. The operator rolls the main lift into the opening in the housing of the stationary storage apparatus until the main wall of the mobile lift contacts the housing of the stationary storage apparatus. The main wall of the mobile lift contacts the housing of the stationary storage apparatus, thereby sealing the opening in the housing. Specifically, the cylinders on the mobile lift, and the cylinders on the racks of the stationary storage apparatus are sealed within the housing. Therefore, if the main wall of the mobile lift is locked to the housing, both the mobile lift and the cylinders are secured in a tamper proof manner. The combination of the mobile lift and the stationary storage apparatus form a secure stationary storage system. Thus, the cylinders are safely secured within the housing, and the mobile lift is locked to the stationary storage apparatus, so that the mobile lift cannot be rolled away and stolen.

Another embodiment of the mobile lift of the present invention comprises:

a main body;

a boom apparatus attached to the main body, wherein the boom apparatus provides rotation of 360 degrees plus an additional rotational angle predetermined by a rotational limiter apparatus; and

an automatic tong apparatus for automatically engaging and disengaging an object to be lifted.

Another embodiment of the apparatus of the present invention comprises:

a mobile main body, having a cylinder storage device;

a boom apparatus attached to the main body; and

a tong apparatus operatively attached to the boom apparatus for engaging an object to be lifted.

The present invention provides a method comprising:

providing a mobile lift including a mobile main body; a boom apparatus attached to the main body; and a tong apparatus operatively attached to the boom apparatus for engaging a cylinder to be lifted;

positioning the tong apparatus proximate the cylinder; and

lowering the tong apparatus and automatically engaging ends of the cylinder with the tong apparatus; and

lifting the cylinder.

### BRIEF DESCRIPTION OF THE DRAWINGS

The features of the present invention will best be understood from a detailed description of the invention and embodiments thereof selected for the purposes of illustration and shown in the accompanying drawings in which:

FIG. 1 illustrates a perspective view of a mobile lift according to an embodiment of the present invention;

FIG. 2 illustrates a cross-sectional view of a tower assembly of the mobile lift taken along line 2-2 of FIG. 1;

FIG. 3 illustrates a side view of a counterweight carrier;

FIG. 4 illustrates a perspective view of a plurality of rotatable counterweights;

FIG. 5 illustrates a side view of the counterweights and counterweight carrier;

FIG. 6 illustrates a side view of a tong apparatus;

FIG. 7 illustrates an end view of the tong apparatus;

FIG. 8 illustrates an end view of cylinders resting on cradles attached to the mobile lift;

FIG. 9 illustrates a side view of the tong apparatus engaged with a cylinder;

FIG. 10 illustrates a side view of each hook arm of the tong apparatus disengaged from a cylinder;

FIG. 11 illustrates a side perspective view of a boom apparatus;

FIG. 12 illustrates a plan view of a support plate of the boom apparatus;

FIG. 13 illustrates a view through an opening in the stationary storage apparatus with cylinders stored in cradles;

FIG. 14 illustrates a main wall of the mobile lift sealing the opening in the stationary storage apparatus forming a secure storage system;

FIG. 15 illustrates a perspective view of the mobile lift attached to the stationary storage apparatus providing the secure storage system for the cylinders and for the mobile lift;

FIG. 16 illustrates a perspective view of the mobile lift transferring a cylinder from the mobile lift to a fork lift truck;

FIG. 17 illustrates a perspective view of a cylinder being placed on a platform of a fork lift truck according to a preferred embodiment of the present invention;

FIG. 18 illustrates a perspective view of another embodiment of a mobile lift;

FIG. 19 illustrates a schematic view of a power apparatus attached to a main body of the mobile lift of FIG. 18;

FIG. 20 illustrates a side view of a boom apparatus;

FIG. 21 illustrates a plan view of a rotational limiter apparatus with a boom of the mobile lift in a neutral position;

FIG. 22 illustrates a plan view of the rotational limiter apparatus limiting rotation of the boom in a counterclockwise direction;

FIG. 23 illustrates a plan view of the rotational limiter apparatus limiting rotation of the boom in a clockwise direction;

FIG. 24 illustrates a side view of a tong apparatus;

FIG. 25 illustrates a side view of the tong apparatus of FIG. 24 suspended above a cylinder;

FIG. 26 illustrates a side view of the tong apparatus with a pair of hook arms automatically engaging with the cylinder;

FIG. 27 illustrates a side view of the tong apparatus including a cylinder hook of each hook arm automatically engaged with each lip of the cylinder.

FIG. 28 illustrates a plan view of a support tray;

FIG. 29 illustrates a side view of the support tray;

FIG. 30 illustrates a front view of a support ladder;

FIG. 31 illustrates a side view of a support apparatus; and

FIG. 32 illustrates a perspective view of the mobile lift with the support tray located adjacent to a rack in the stationary storage apparatus.

### DETAILED DESCRIPTION OF THE INVENTION

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the preferred embodiment. The features and advantages of the present invention are illustrated in detail in the accompanying drawings, wherein like reference numerals refer to like elements throughout the drawings.

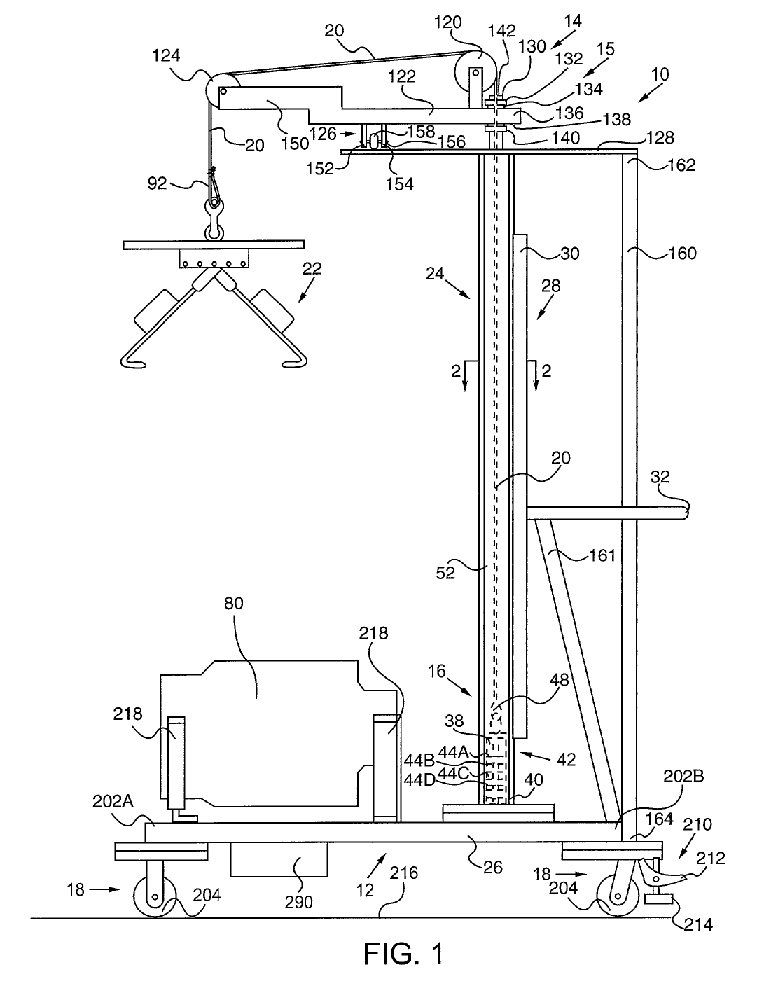

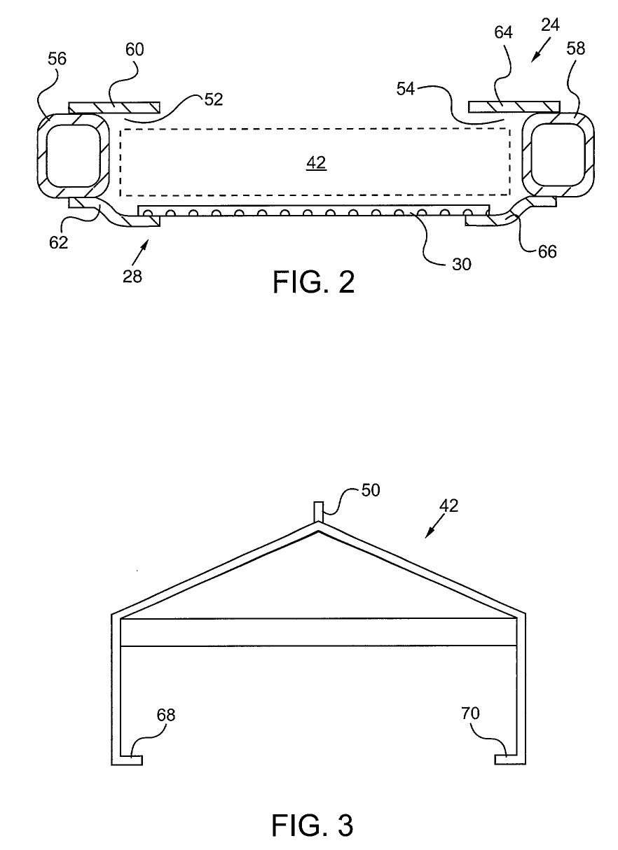

Referring to FIG. 1, there is illustrated a perspective view of a mobile lift 10 according to a preferred embodiment of the present invention. The mobile lift 10 includes a main body 12, a boom apparatus 14, a counterweight apparatus 16, wheel assemblies 18, a lift cable 20, and a tong apparatus 22. Included in the main body 12 is a tower assembly 24 attached to a main frame 26. The tower assembly 24 includes a main wall 28 including a fence 30 (FIG. 2). As illustrated in FIG. 1, a push handle 32 and the boom apparatus 14 are attached to the tower assembly 24.

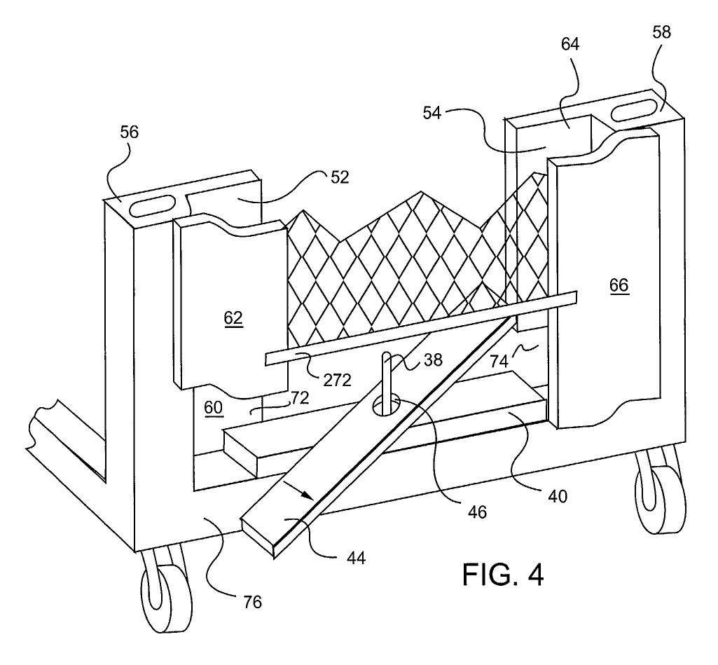

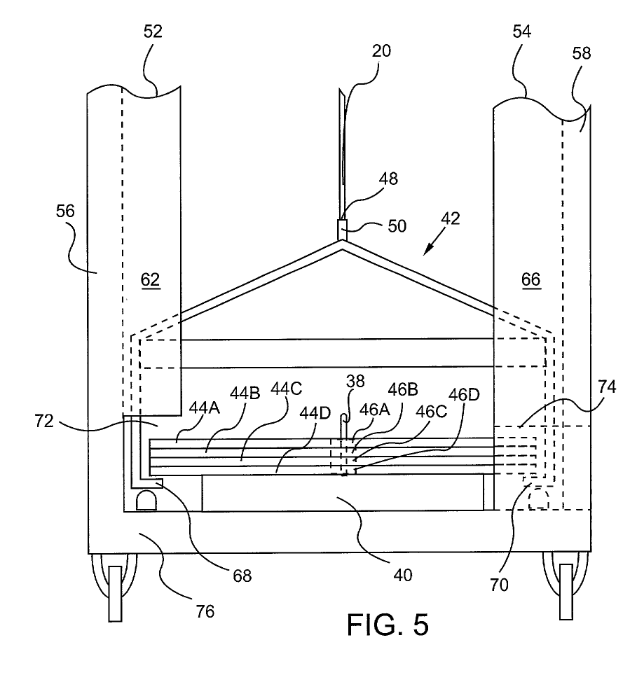

The counterweight apparatus 16 is illustrated in FIGS. 1 through 5. The counterweight apparatus 16 includes a vertical guide 52 and a vertical guide 54. In addition, the counterweight apparatus 16 includes a pivot post 38, a counterweight support 40, a counter weight carrier 42, and a plurality of counterweights 44A, 44B, 44C, and 44D (FIG. 5). Each counterweight 44 has a centrally located hole 46 as illustrated in FIG. 4. The counterweights 44A, 44B, 44C, and 44D are stacked and stored with the pivot post 38 passing through the hole 46A, 46B, 46C, and 46D in each counterweight 44 (FIG. 5). The total weight attached to a second end 48 of the lift cable 20 is determined by adding the counterweight carrier 42 weight to the combined weight of the individual counterweights 44 that are supported by the counterweight carrier 42. The second end 48 of the lift cable 20 is attached to the counterweight carrier 42 with a swivel connector 50. The counterweight carrier 42 moves in a vertical direction and rides in the vertical guide 52 and the vertical guide 54.

FIG. 2 illustrates a cross-sectional view of the tower assembly 24 taken along line 2-2 of FIG. 1. The tower assembly 24 includes a tower post 56 and a tower post 58. A guide wall 60 and a guide wall 62 are rigidly attached to the tower post 56 forming the vertical guide 52. A guide wall 64 and a guide wall 66 are rigidly attached to the tower post 58 forming the vertical guide 54. The counterweight carrier 42 (shown in phantom) rides in the guides 52 and 54.

FIG. 3 illustrates a side view of the counterweight carrier 42. The counterweight carrier 42 includes a hook 68 and a hook 70 to support the counterweights 44. In order to obtain a desired total counterweight, the operator can select one or more counterweights 44 to be lifted by the hooks 68 and 70. As illustrated in FIG. 4, each counterweight 44 can rotatably pivot about the pivot post 38. Each counterweight is selected for lifting by rotating the counterweight 44 in a clockwise direction. In this position, the counterweight 44 is lifted by the hooks 68 and 70 (FIG. 5). Each counterweight can be rotated in a counter-clockwise direction to deselect the counterweight 44 for lifting. FIG. 4 illustrates a counterweight 44 in a counter-clockwise deselected position. The selection process is accomplished in the lower portion of the vertical guides 52 and 54 where there are openings 72 and 74 to allow the counterweights 44 to be rotated. Guide wall 62 ends before reaching element 76 which creates the opening 72, and guide wall 64 ends before reaching element 76 which creates the opening 74 (FIGS. 4 and 5).

To add counterweight, the operator first rotates counterweights 44A, 44B, 44C, and 44D in a counter-clockwise direction. Weights are added for lifting by the counterweight carrier 42 by rotating in a clockwise direction successive counterweights 44 in the order of 44A, 44B, 44C, and 44D (FIG. 5). Weights are subtracted from the counterweight carrier 42 by rotating in a counter-clockwise direction successive counterweights 44 in the order of 44D, 44C, 44B, and 44A (FIG. 5). Therefore, in the preferred embodiment of the present invention, the operator engages counterweights 44 for lifting by rotation and, thus, never has to lift counterweights 44. This prevents back injuries and allows operators who are not physically strong to handle heavy counterweights 44. The combined weight of the counterweight carrier 42 and the selected counterweights 44 are preferably about the same weight of the cylinder being lifted. Individually selected counterweights 44 provide weight compensation for a full or empty cylinder 80.

In the present invention, each counterweight 44 weighs about 12 pounds and the counterweight carrier 42 weighs about 23 pounds. Empty cylinders 80 weigh between about 27 and 35 pounds each, and full cylinders 80 weigh between about 60 and 80 pounds each. Counterweights 44 are selected to counterbalance within about 10 pounds of the total weight of the cylinder 80. For stability and control, the 10 pound differential ensures that the cylinder, if left unattended, will always safely return to the ground. At the same time, the operator only has to provide about 10 pounds of force to lift the cylinder 80.

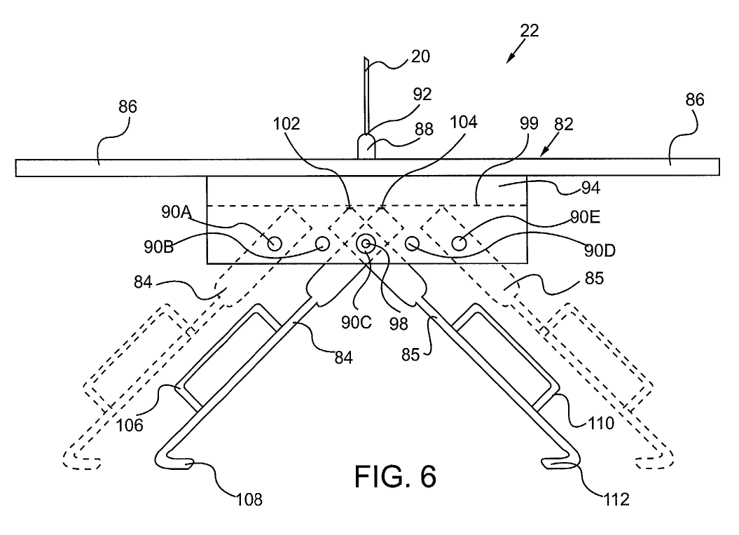

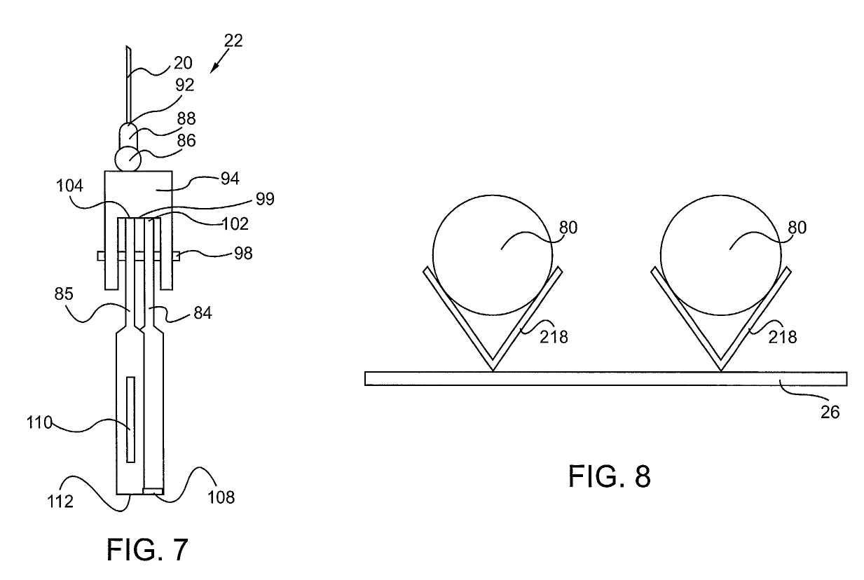

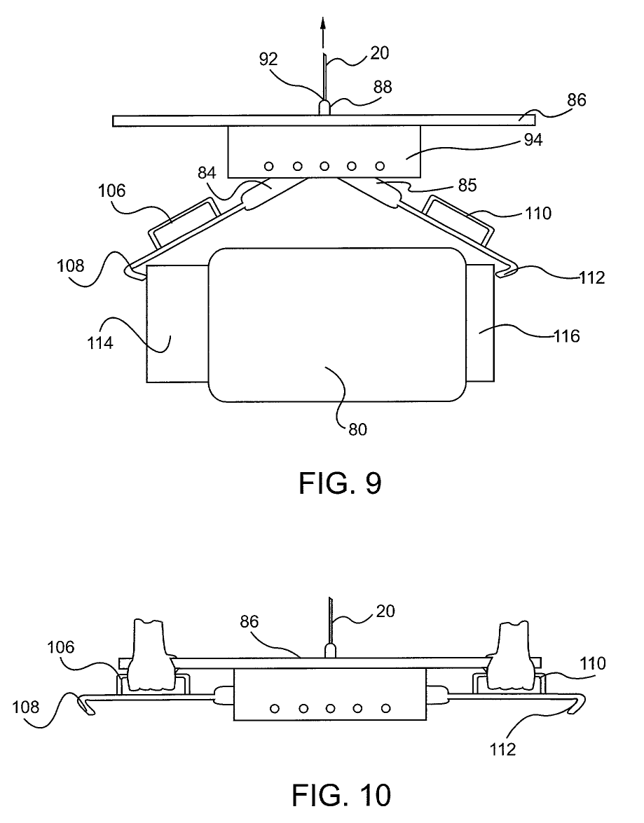

The tong apparatus 22 for engaging a cylinder 80 is illustrated in FIGS. 6 and 7. FIG. 6 illustrates a side view and FIG. 7 illustrates an end view of the tong apparatus 22. The tong apparatus 22 includes a tong main body 82, a hook arm 84, and a hook arm 85. The tong main body 82 includes a guidance handle 86, a main support housing 94, and a loop 88 for attachment to a first end 92 of the lift cable 20. The lift cable 20 is swivelably attached to the loop 88. The guidance handle 86 is attached to the main support housing 94 and the loop 88 is attached to the guidance handle 86. The guidance handle 86 is grasped by the operator and is used to lift, lower and rotate the cylinder 80 into a desired location (FIG. 9).

As illustrated in FIG. 6, the hook arm 84 and the hook arm 85 are pivotally attached with a pivoting pin 98 to the tong main body 82 at a pivot hole 90C. The tong main body 82 includes a plurality of holes 90A, 90B, 90C, 90D, and 90E to enable the pivot locations for the hook arms 84 and 85 to be moved in order to accommodate different cylinder 80 lengths. For example, hook arm 84 is shown in phantom located at pivot hole 90A, and hook arm 85 is shown in phantom located at pivot hole 90E. The main support housing 94 includes an inner flat surface 99. The downward extent of travel of the hook arm 84 is determined when the contact surface 102 of the hook arm 84 contacts the inner flat surface 99 of the main support housing 94. The downward extent of travel of the hook arm 85 is determined when the contact surface 104 of the hook arm 85 contacts the inner flat surface 98 of the main support housing 94.

The hook arm 84 includes a control handle 106 and a cylinder hook 108. Similarly, the hook arm 85 includes a control handle 110 and a cylinder hook 112. FIG. 9 illustrates the cylinder hook 108 engaged in a first end 114 of the cylinder 80, and the cylinder hook 112 engaged in a second end 116 of the cylinder 80. When an operator lifts the cylinder 80 using the guidance handle 86, the counterweight apparatus 16 attached to the second end 48 of the lift cable 20 counterbalances the weight of the cylinder 80. As illustrated in FIG. 10, the operator releases the cylinder hooks 108 and 112 from engagement with the ends 114 and 116 of the cylinder 80 by pulling in an upward direction on the control handles 106 and 110. The operator can simultaneously grasp the control handles 106, 110, and the guidance handle 86 as illustrated in FIG. 10.

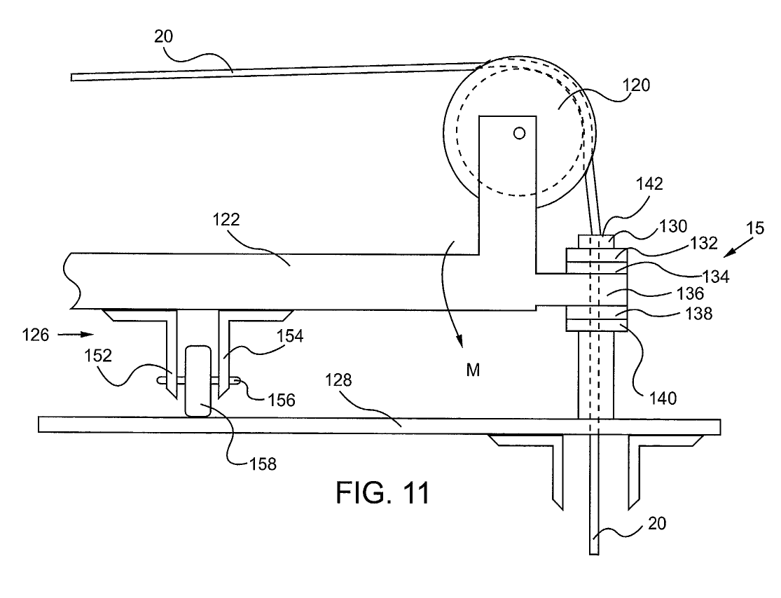

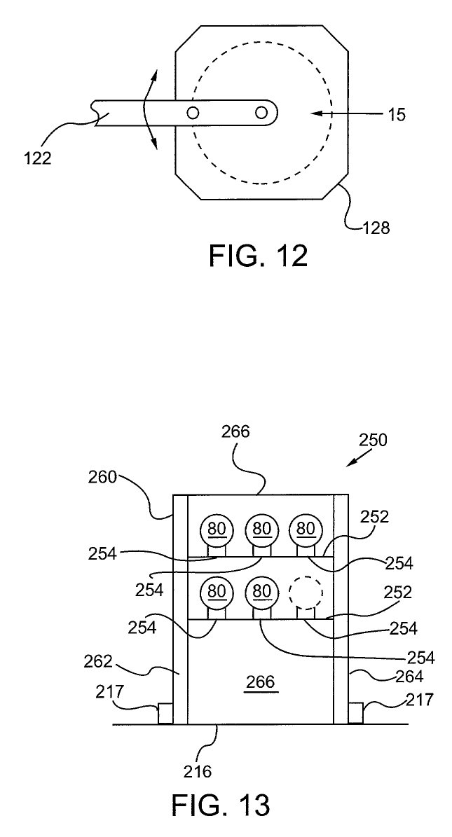

As illustrated in FIG. 1, the boom apparatus 14 is attached to the tower assembly 24. Further illustrations of the boom apparatus are included in FIGS. 11 and 12. The boom apparatus 14 includes a pivot apparatus 15, a sheave 120, a boom arm 122, a sheave 124, a wheel assembly 126, and a support plate 128 (FIG. 1 and 11). The boom arm 122 can pivot 360 degrees around the pivot apparatus 15 enabling the mobile lift 10 to move an object 360 degrees around the mobile lift (FIG. 12). The pivot apparatus 15 includes a pivot stud 130, a shaft collar 132, a thrust washer 134, a shaft collar 136, a shoulder bushing 138, and a shaft collar 140. A central vertical hole 142 passes through the pivot apparatus 15 and allows the lift cable 20 to pass through the pivot apparatus 15. The sheave 124 and the sheave 120 are pivotally attached to the boom arm 122, thereby allowing the cable to travel over the boom arm 122. An outer portion 150 of the boom arm 122 is located at a higher elevation to provide increased clearance between the boom arm 122 and the tong apparatus 22 (FIG. 1).

As illustrated in FIG. 11, the wheel assembly 126 includes support legs 152 and 154, a wheel axle 156, and a boom support wheel 158. The support legs 152 and 154 are attached to the boom arm 122 and support the wheel axle 156. The boom support wheel 158 rotates about the wheel axle 156, and contacts and rolls on the support plate 128. The boom support wheel 158 transfers a portion of the lifting load (i.e. cylinder 80 weight) and the boom arm 122 weight to the support plate 128, thus reducing the bending moment (M) applied to the pivot apparatus 15 (FIG. 11). As illustrated in FIG. 1, a first end 162 of a support 160 is attached to the support plate 128 and a second end 164 of the support 160 is attached to the main frame 26. The support 160 provides support to the support plate 128. A diagonal brace 161 is attached between the push handle 32 and the main frame 26 (FIG. 1).

As illustrated in FIG. 1, the first end 92 of the lift cable 20 is attached to the tong apparatus 22. Next, the lift cable 20 passes over the sheave 124, over the sheave 120, down through the central vertical hole 142, and down to the second end 48 of the lift cable which is attached to the counterweight apparatus 16.

As illustrated in FIG. 1, the wheel assemblies 18 are attached to the main frame 26. In the present invention, the main frame 26 is rectangular in shape and a wheel assembly 18 is attached near each corner 202A, 202B, 202C, and 202D of the main frame 26. Each wheel assembly 18 includes a wheel 204, that may be pivotally mounted, to assist the operator in moving the mobile lift 10 in any horizontal direction. A foot brake assembly 210 is attached to one end of the main frame 26. The foot brake assembly 210 includes a foot pedal 212, and a support pad 214. When the operator steps on the foot pedal 212, the support pad 214 moves in a downward direction and contacts a floor surface 216. When the support pad 214 contacts the floor surface 216, the mobile lift is held in one location while the operator lifts and moves a cylinder 80. When the operator lifts the support pad 214 away from the floor surface 216, the mobile lift 10 is once again free to move.

FIGS. 1 and 8 illustrate a plurality of cradles 218 supporting cylinders 80. The cradles 218 are attached to the main frame 26. In the preferred embodiment of the present invention, at least two cylinders 80 are supported by the cradles 218 on the main frame 26. The cradles 218 provide storage support for full and empty cylinders 80.

In accordance with the present invention, the operator rotates the boom arm 122 into a position over the cylinder 80 to be lifted. The operator rotates the required counterweights 44 for engagement with the hooks 68 and 70 of the counterweight carrier 42 (FIGS. 4 and 5). Next, the operator engages the cylinder hooks 108 and 112 with the cylinder 80 (FIG. 9). By grasping the guidance handle 86 of the tong apparatus 92, the operator can lift, move, and lower the cylinder 80 to the cradles 218 attached to the main frame 26. Next, the operator grasps the push handle 32 attached to the mobile lift 10 and moves the mobile lift 10 to a location where the cylinder 80 is required.

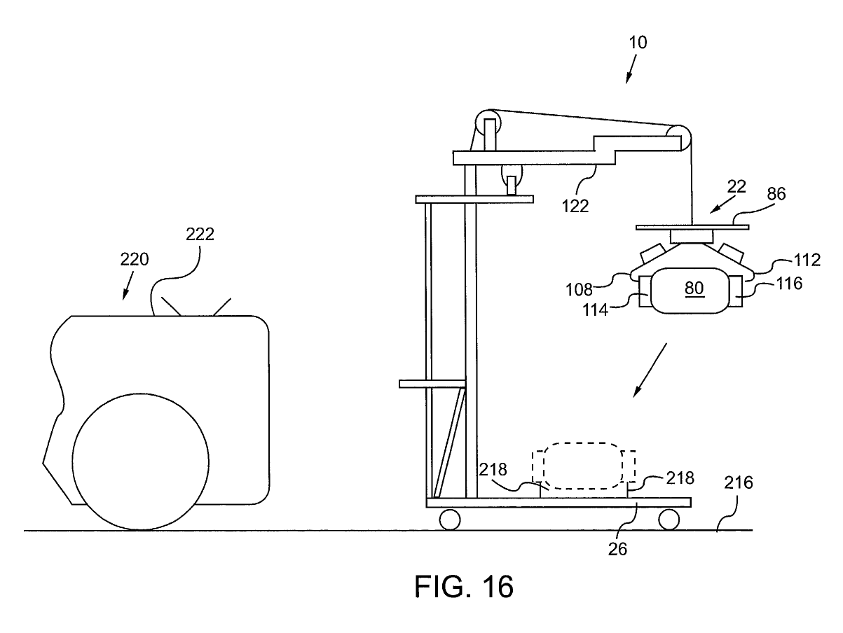

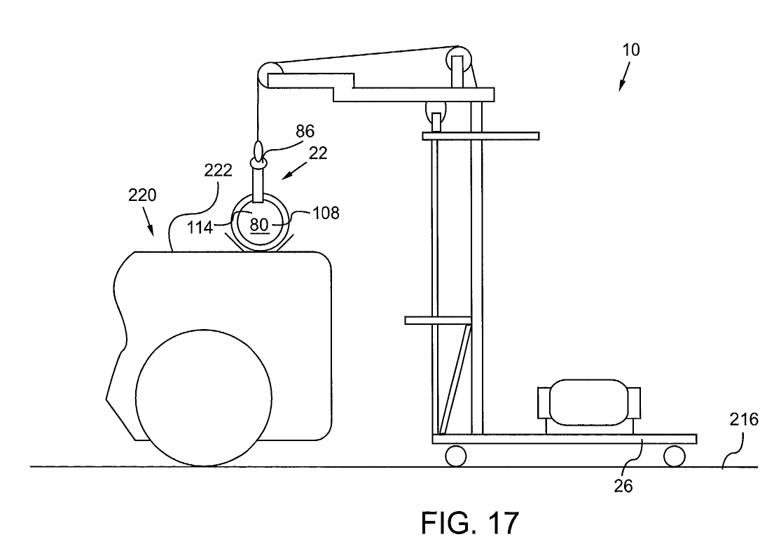

FIGS. 16 and 17 illustrate cylinders 80 being moved from a fork lift truck 220. For example, if the operator is replacing an empty cylinder 80 on a fork lift truck 220, the operator engages the cylinder hooks 108 and 112 of the tong apparatus 22 onto the ends 114 and 116 of the cylinder 80. The operator grasps the guidance handle 86 of the tong apparatus 22 and lifts, moves, and lowers the empty cylinder 80 to the cradles 218 on the main frame 26. The pivoting boom arm 122 allows the operator to easily move the empty cylinder 80 from a location above the fork lift truck 220 to a location above the empty cradles 218 on the main frame 26 (FIG. 16). Next, the operator reverses the process and uses the mobile lift 10 to lift, move, and lower a full cylinder 80 from the cradles 218 on the main frame 26 to a platform 222 on the fork lift truck 220 (FIG. 17).

The operator then rolls the mobile lift 10 to a stationary storage apparatus 250. The stationary storage apparatus 250 is illustrated in FIGS. 13, 14, and 15. The stationary storage apparatus 250 provides a secure location where empty and full cylinders 80 can be stored. The stationary storage apparatus 250 can be anchored to the floor surface 216 by an anchoring apparatus 217, or the weight included in the stationary storage apparatus 250 may be sufficient to prevent movement. The stationary storage apparatus 250 includes racks 252 with cradles 254 for receiving and supporting a plurality of empty and full cylinders 80. The racks 252, cradles 254, and cylinders 80 are located inside a housing 260. The housing 260 includes three walls 262, 264, and 266, and rests on the floor surface 216. Therefore, the housing 250 includes a single opening 266 for receiving a portion of the mobile lift 10 (FIG. 13).

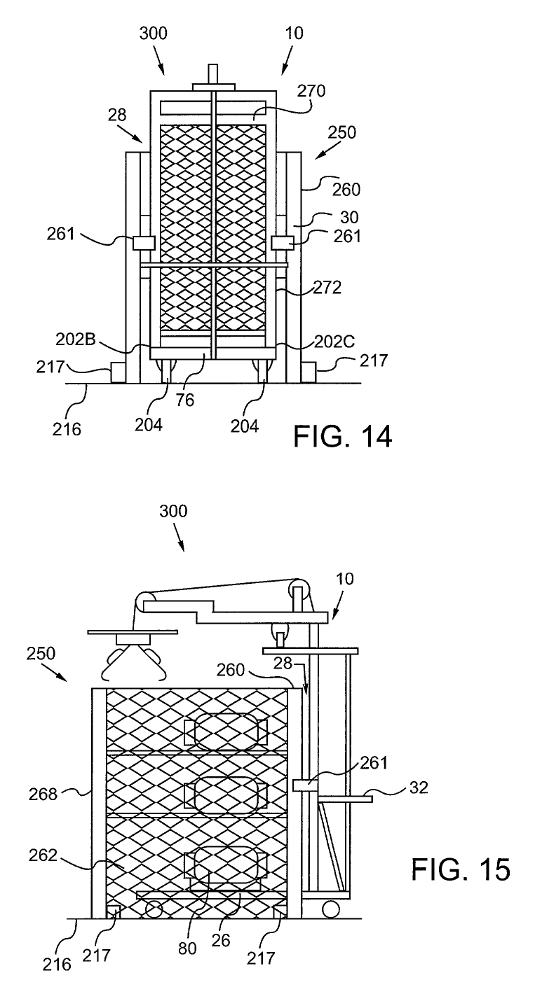

Included in the tower assembly 24 of the main body 12 of the mobile lift 10 is the main wall 28. As illustrated in FIGS. 1, 2, 4, and 14, the main wall 28 includes the fence 30 which is rigidly attached to the guide wall 62, the guide wall 66, a cross-brace 270, and a cross-brace 272. The operator can roll the mobile lift 10 into the opening 266 in the housing 260 of the stationary storage apparatus 250. As illustrated in FIGS. 14 and 15, the main wall 28 of the mobile lift 10 contacts the housing 260, thereby sealing the opening 266 in the housing 260. Specifically, the cylinders 80 on the mobile lift 10, and the cylinders 80 on the racks 252 of the stationary storage apparatus 250 are sealed within the housing 260. Therefore, if the main wall 28 of the mobile lift 10 is secured by a locking apparatus 261 to the housing 260, both the mobile lift 10 and the cylinders 80 are secured from theft (FIGS. 14 and 15). Therefore, the combination of the mobile lift 10 and the stationary storage apparatus 250 form a stationary storage system 300 as illustrated in FIG. 15. Thus, the cylinders 80 are secured within the housing 260, and since the mobile lift 10 is locked to the stationary storage apparatus 250, the mobile lift 10 cannot be rolled away and stolen.

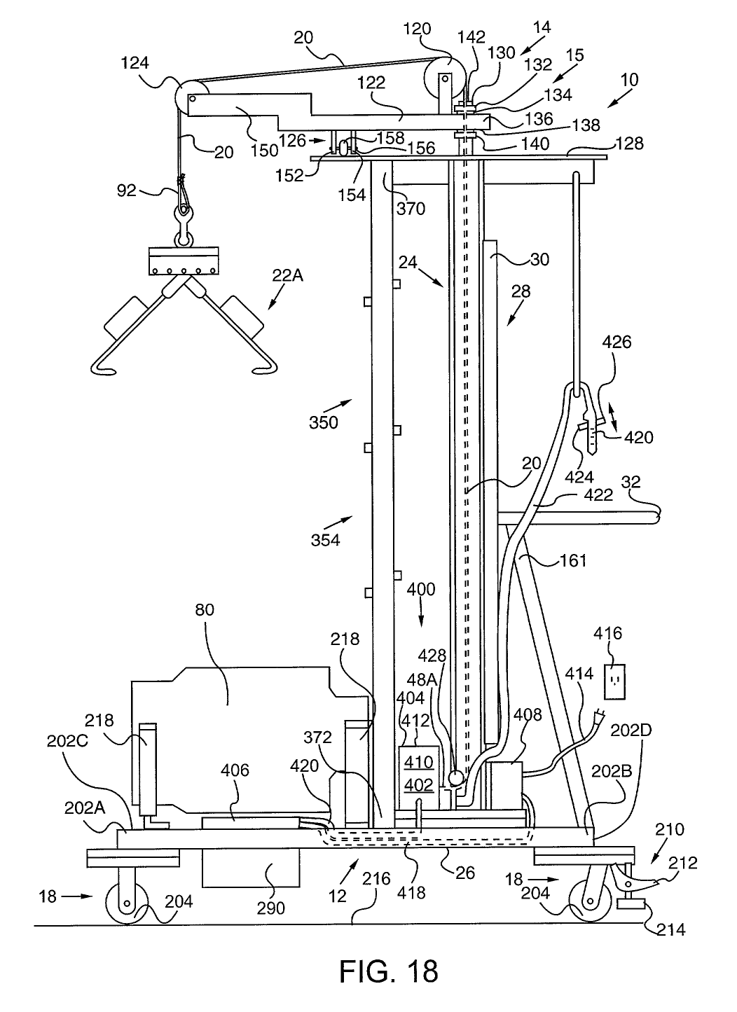

FIG. 18 illustrates another embodiment of a mobile lift 10A in accordance with the present invention. The mobile lift 10A includes the main body 12, the boom apparatus 14, wheel assemblies 18, the lift cable 20, a support apparatus 350, a power apparatus 400, and an automatic tong apparatus 22A. Included in the main body 12 is a tower assembly 24 attached to the main frame 26. The tower assembly 24 may include a main wall 28 including a fence 30 (see, e.g., FIG. 2). A push handle 32 and the boom apparatus 14 are attached to the tower assembly 24.

As illustrated in FIG. 18, the wheel assemblies 18 are attached to the main frame 26. In the present invention, the main frame 26 is rectangular in shape and a wheel assembly 18 is attached near each corner 202A, 202B, 202C, and 202D of the main frame 26. Each wheel assembly 18 includes the wheel 204, that may be pivotally mounted, to assist the operator in moving the mobile lift 10 in any horizontal direction. The foot brake assembly 210 is attached to one end of the main frame 26. The foot brake assembly 210 includes the foot pedal 212, and the support pad 214. When the operator steps on the foot pedal 212, the support pad 214 moves in a downward direction and contacts the floor surface 216. When the support pad 214 contacts the floor surface 216, the mobile lift is held in one location while the operator lifts and moves the cylinder 80. When the operator lifts the support pad 214 away from the floor surface 216, the mobile lift 10A is once again free to move.

FIGS. 8 and 18 illustrate the plurality of cradles 218 supporting cylinders 80. The cradles 218 are attached to the main frame 26. Typically, at least two cylinders 80 are supported by the cradles 218 on the main frame 26. The cradles 218 provide storage support for full and empty cylinders 80.

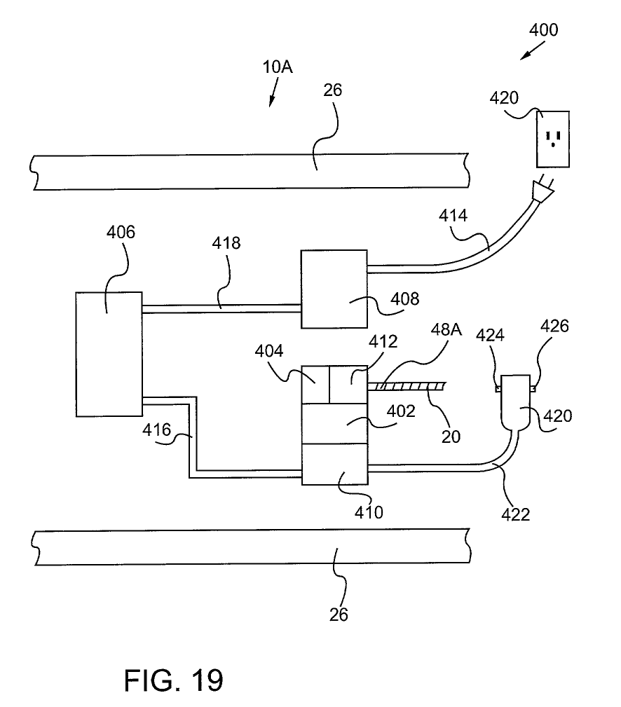

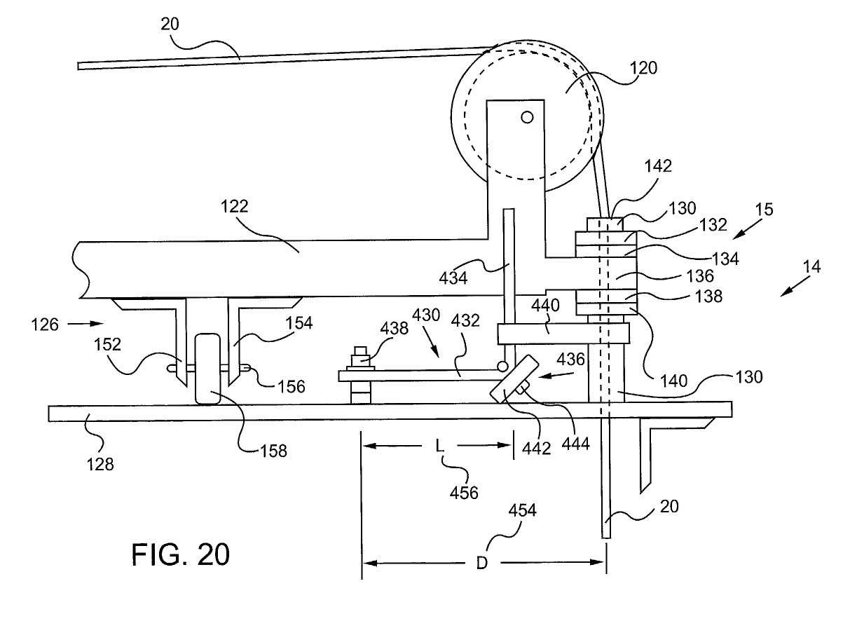

The power apparatus 400 is illustrated in FIGS. 18 and 19. The power apparatus 400 includes a motor 402, a winch appratus 412, a brake apparatus 404, a battery 406, a charger 408, and a control system 410. The power apparatus 400 is attached to the main frame 26 of the mobile lift 10A. An electrical power cord 414 removably connects a power outlet 416 with the charger 408. Electrical power is carried from the power outlet 416 to the charger 408. A conduit 418 connects the charger 408 with the battery 406. The conduit 418 carries electrical power from the charger 408 to the battery 406 to charge the battery 406. A conduit 420 connects the battery 406 with the control system 410. The battery 406 carries electrical power from the battery 406 to the control system 410. A conduit 422 connects a control module 420 with the control system 410. The control module 420 includes an “on-off” switch 424, and a direction switch 426. An operator may depress the “on-off” switch 424 sending a command to the control system 410 for connecting power from the battery 406 to the motor 402. The operator may select the rotational direction of the motor 402 by moving the direction switch 426 in an upward or downward direction. The motor 402 rotates the winch apparatus 412 which is connected to a second end 48A of the lift cable 20. The brake apparatus 404 stops the rotation of the winch apparatus 412 whenever electrical power is removed from the motor 402.

As illustrated in FIG. 18, the first end 92 of the lift cable 20 is attached to the automatic tong apparatus 22A. Next, the lift cable 20 passes over the sheave 124, over the sheave 120, down through the central vertical hole 142, down to a lower sheave 428, and to the second end 48A of the lift cable 20. Alternatively, the lower sheave 428 may be eliminated with the second end 48A of the lift cable 20 connected to the winch apparatus located in-line with the central vertical hole 142. The operator may use the direction switch 426 to select a lifting or lowering direction of the tong apparatus 22A. The operator may start or stop vertical movement of the tongs by depressing the “on-off” switch 424.

Unlimited rotation of the boom arm 122 in the same direction can cause the lift cable 20 to twist, kink, and fatigue. To prevent this cable damage, a rotational limiter apparatus 430 is provided to limit the rotation of the boom arm 122, as illustrated in FIG. 20. The rotational limiter apparatus 430 includes a pivot arm 432, a limit arm 434, a pivot arm support wheel apparatus 436, a mounting post 438, and a resilient member 440. The pivot arm 432 is pivotally attached to the support plate 128 by the mounting post 438. The limit arm 434 is attached vertically to the pivot arm 432. The pivot arm support wheel apparatus 436 includes a wheel 442 and an axle 444. The wheel 442 is rotationally attached to the pivot arm 432 by the axle 444. The wheel 442 contacts the support plate 128 and provides support to the pivot arm 432. The resilient member 440 elastically connects the limit arm 434 with the pivot stud 130 of the boom apparatus 14. The resilient member 440 may include any suitable elastic element (e.g., rubber band, spring, etc.).

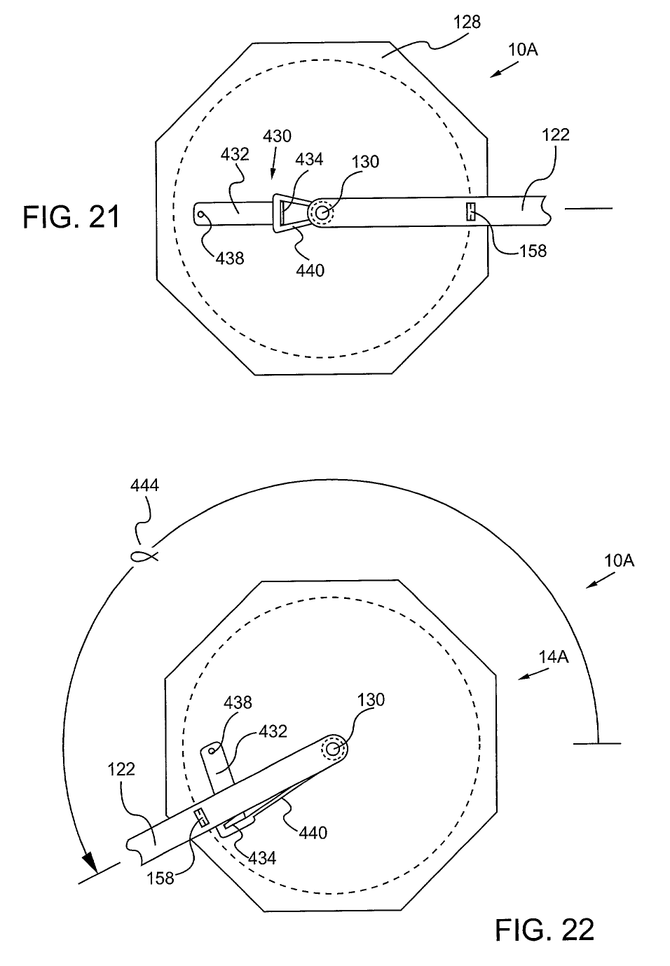

FIG. 21 illustrates a plan view of the rotational limiter apparatus 430 with the boom arm 122 of the mobile lift 10A in a neutral position. The resilient member 440 is stretched and continuously provides a bias force that pulls the limit arm 434 towards the neutral position (FIG. 21). FIG. 22 illustrates a plan view of the rotational limiter apparatus 430 limiting rotation of the boom arm 122 in a counterclockwise direction. The boom arm 122 is rotated an angle “α” 444 greater than 180 degrees before the boom arm 122 rotation is stopped by the limit arm 434. The boom arm 122 presses against the limit arm 434 which causes the pivot arm 432 to rotate about the mounting post 438 in a clockwise direction until the boom arm 122 is substantially perpendicular to the pivot arm 432. At this point, the rotation of the boom arm 122 is stopped (FIG. 22). As the boom arm 122 is rotated in a clockwise direction, the resilient member 440 pulls the limit arm 434 back towards the neutral position as illustrated in FIG. 21.

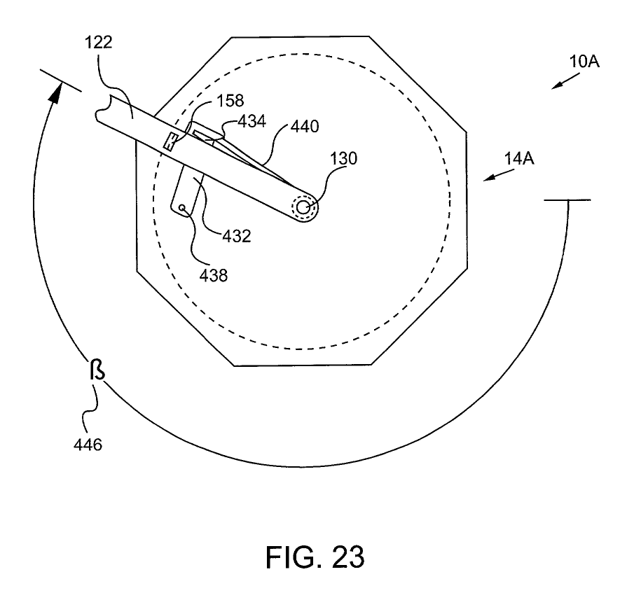

FIG. 23 illustrates a plan view of the rotational limiter apparatus 430 limiting rotation of the boom in a clockwise direction. The boom arm 122 is rotated an angle “β” greater than 180 degrees before the boom arm 122 rotation is stopped by the limit arm 434. The boom arm 122 presses against the limit arm 434 which causes the pivot arm 432 to rotate about the mounting post 434 in a counterclockwise direction until the boom arm 122 is substantially perpendicular to the pivot arm 432. At this point, the rotation of the boom arm 122 is stopped (FIG. 23). As the boom arm 122 is rotated in a counterclockwise direction, the resilient member 440 pulls the limit arm 434 back towards the neutral position (FIG. 21).

As illustrated in FIG. 20, a distance “D” 454 is measured between the mounting post 438 of the rotational limiter apparatus 430 and the pivot stud 130 of the boom apparatus 14. A distance “L” 456 is the length of the pivot arm 432 between the mounting post 438 and the limit arm 434. The angle “α” 444 is dependent upon the distance “D” 454 and the length “L” 456. As “D” 454 and “L” 456 are increased, the angle “α” 444 increases. For a constant “D” 454, the angle “α” 444 increases as the length “L” 456 is increased. The maximum angle “α” 444 possible is about 270 degrees and the minimum angle “α” 444 is slightly greater than 180 degrees. In a similar manner, the maximum angle “β” 466 is about 270 degrees and the minimum angle “β” 446 is slightly greater than 180 degrees. As illustrated in FIGS. 22 and 23, the boom arm 122 is limited to a total rotation of the sum of the angle “α” 444 plus the angle “β” 446 which is greater than 360 degrees but less than about 540 degrees. Therefore, the rotational limiter apparatus 430 prevents the boom arm 122 from being rotated an unlimited amount in either a clockwise or counterclockwise direction. This prevents the lift cable 20 from becoming twisted, kinked or fatigued.

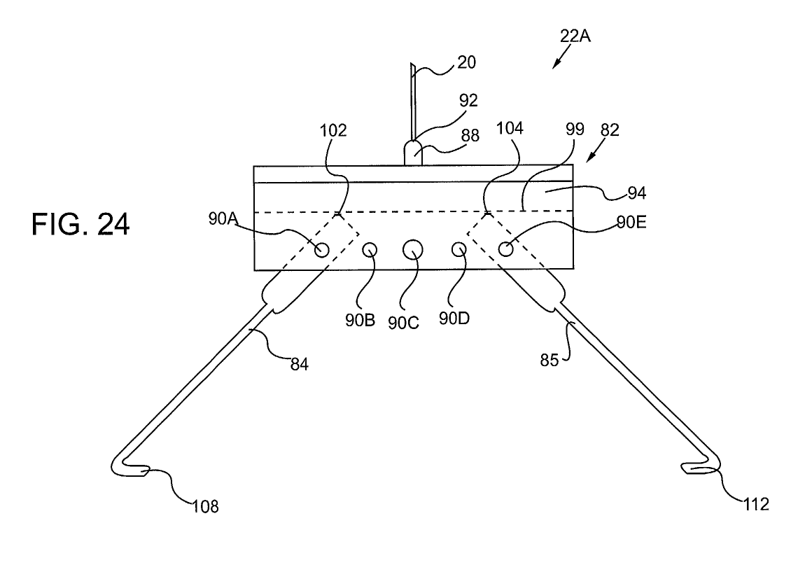

FIG. 24 illustrates another embodiment of the automatic tong apparatus 22A. The automatic tong apparatus 22A is similar to the tong apparatus 22 without the control handles 106 and 110, and without the guidance handle 86 (FIG. 6). The automatic tong apparatus 22A includes the tong main body 82, the hook arm 84 and the hook arm 85. The hook arm 84 includes the cylinder hook 108, and the hook arm 85 includes the cylinder hook 112. The tong main body 82 includes a main support housing 94, and the loop 88 for attachment to the first end 92 of the lift cable 20. The lift cable 20 is swivelably attached to the loop 88.

As illustrated in FIG. 24, the hook arm 84 and the hook arm 85 may be pivotally attached to the tong main body 82 at selected holes 90A-90E formed in the tong main body 82. For example, hook arm 84 is shown pivotally attached at hole 90A and hook arm 85 is shown pivotally attached at hole 90E. The hook arms 84, 85 may be pivotally attached to the tong main body 82 by using any suitable means (e.g., bolts, pins, etc.). The main support housing 94 includes an inner flat surface 99. The downward extent of travel of the hook arm 84 is determined when the contact surface 102 of the hook arm contacts the inner flat surface 99 of the main support housing 94. The downward extent of travel of the hook arm 85 is determined when the contact surface 104 of the hook arm 85 contacts the inner flat surface 99 of the main support housing 94. Gravity pulling on the hook arms 84 and 85 causes them to automatically swing downward until the contact surfaces 102 and 104 contact the inner flat surface 99.

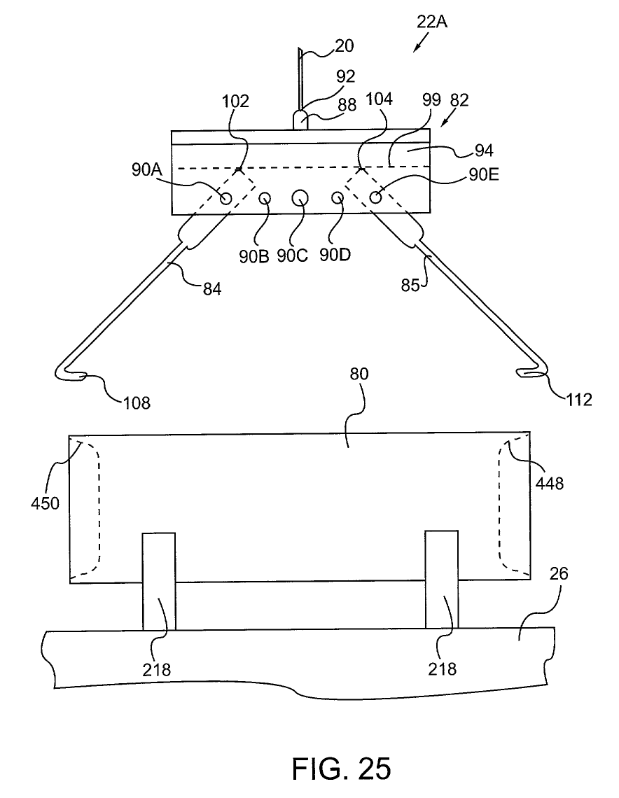

FIG. 25 illustrates the automatic tong apparatus 22A suspended above the cylinder 80. The cylinder 80 is resting upon any suitable support (e.g., cradle 218, fork lift 220, etc.). The cylinder 80 includes a first lip 448 and a second lip 450. The contact surfaces 102 and 104 of the hook arms 84 and 85, respectively, are in contact with the inner flat surface 99 of the main support housing 94.

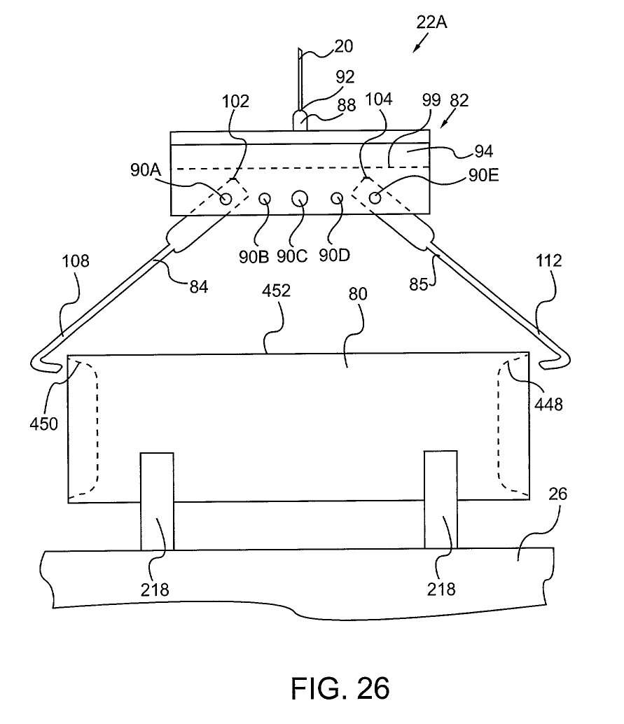

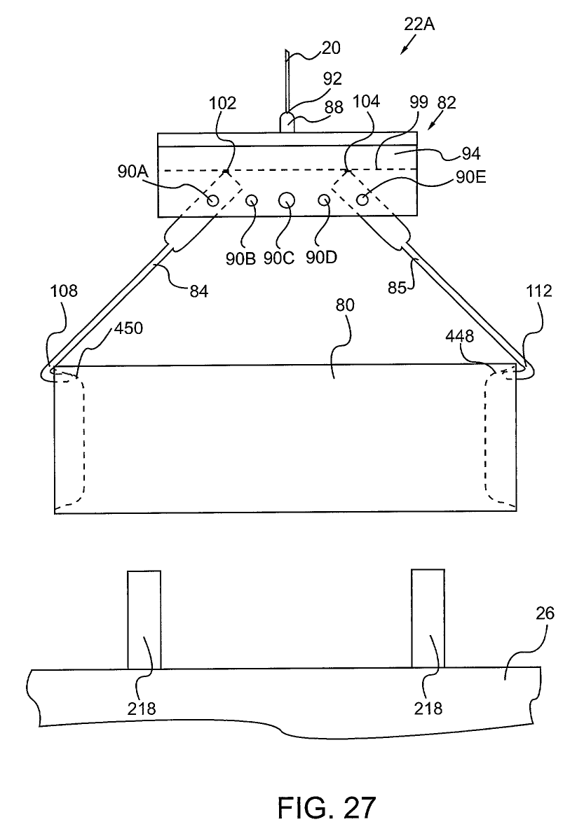

FIG. 26 illustrates the automatic tong apparatus 22A after the automatic tong apparatus 22A has been lowered towards the cylinder 80. The hook arms 84 and 85 are contacting the cylinder 80 causing the hook arm 84 to rotate in a clockwise direction, and the hook arm 85 to rotate in a counterclockwise direction. The cylinder hooks 108 and 112 are below the top surface 452 of the cylinder 80. Next, the automatic tong apparatus 22A is lifted away from the support cradles 218, allowing the hook arms 84 and 85 to automatically swing towards the cylinder 80. Gravity pulling on the hook arms 84 and 85 causes them to automatically swing towards the cylinder 80. This self actuating movement of the hook arms 84 and 85 causes the cylinder hooks 112 and 108 to engage with the first lip 448 and the second lip 450 of the cylinder 80 as illustrated in FIG. 27. As the automatic tong apparatus 22A is lifted with the lift cable 20, the cylinder 80 is lifted away from the support cradles 218. The operator may raise or lower the cylinder 80 using the control module 420, and the operator may grasp the cylinder 80 to rotate the boom arm 122 by moving the cylinder 80 in a horizontal direction.

Reversing the process, the operator lowers the cylinder 80 onto a desired support (e.g., cradle 218, fork lift 220, etc.) using the control module 420. After the cylinder contacts the cradles 218, the operator continues to lower the automatic tong apparatus 22A until the hook arms 84 and 85 rotate away from the cylinder 80. This causes the cylinder hooks 112 and 108 to automatically disengage from the first lip 448 and the second lip 450 of the cylinder 80 (FIG. 26). Next, the operator moves the automatic tong apparatus 22A away from the cylinder 80 in a horizontal direction. The automatic tong apparatus 22A is then completely clear of the cylinder 80 and may be positioned above another cylinder 80 to be lifted.

A ballast apparatus 290 (FIG. 18) providing adjustable weight can be attached to the main frame 26. The ballast apparatus 290 can prevent the mobile lift 10A from tipping when the boom arm 122 is extended toward the push handle 32 end of the mobile lift 10A. The ballast apparatus 290 may include weights of any suitable material (e.g., concrete blocks, cast iron, etc.). The wheels, 204 may be turned by a motor (e.g., electric or gas) to propel the mobile lift 10A across the floor surface 216.

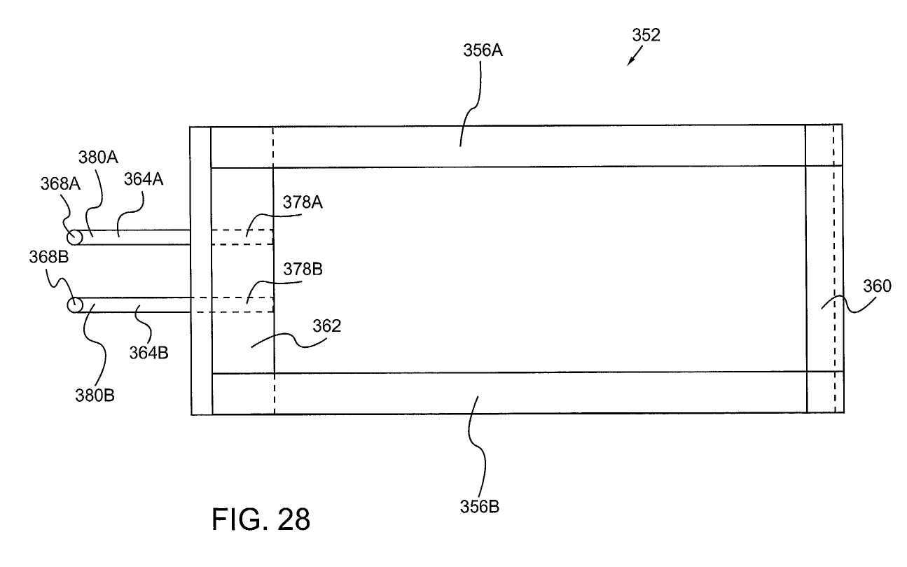

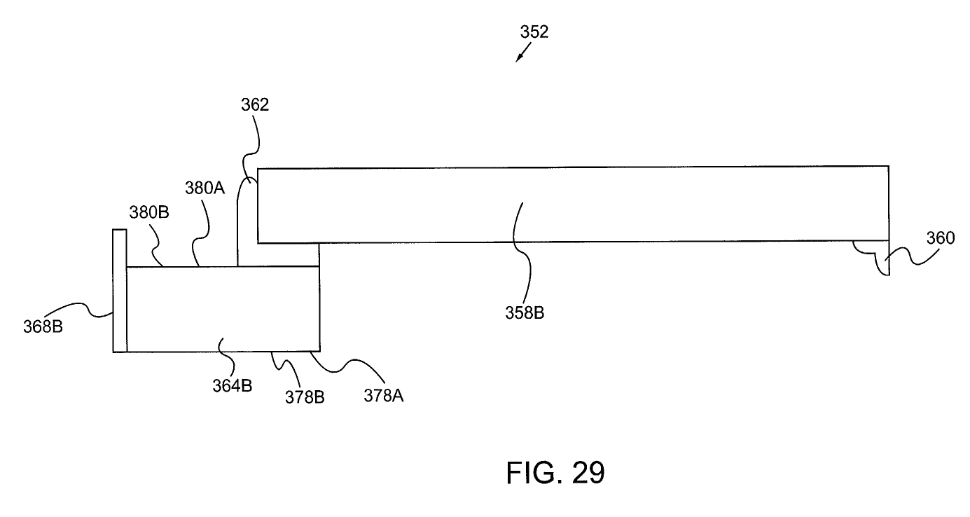

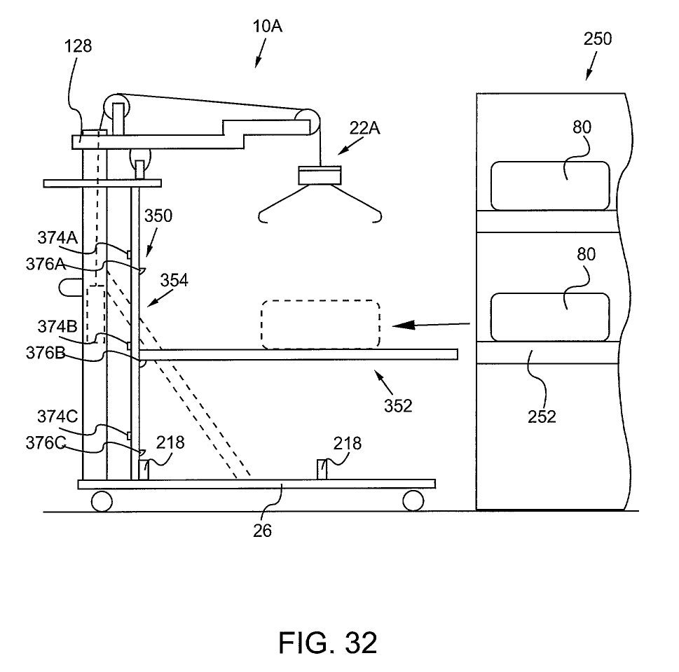

As illustrated in FIGS. 28-32, the present invention includes the support apparatus 350 including a tray 352 and a support ladder 354. The tray 352 may be adjustably positioned on the support ladder 354 to correspond with a selected level of one of the racks 252 of the stationary storage apparatus 250 as illustrated in FIG. 32. FIGS. 28 and 29 illustrate the tray 352 including a member 356A, a member 356B, a cross-member 360, a cross-member 362, a base element 364A, a base element 364B, a post 368A, and a post 368B. The members 356A and 356B are attached to the cross-members 360 and 362 forming a support structure for an object such as a cylinder 80. The base elements 364A and 364B are attached to the cross-member 362. The post 368A is attached to the base element 364A and the post 368B is attached to the base element 364B.

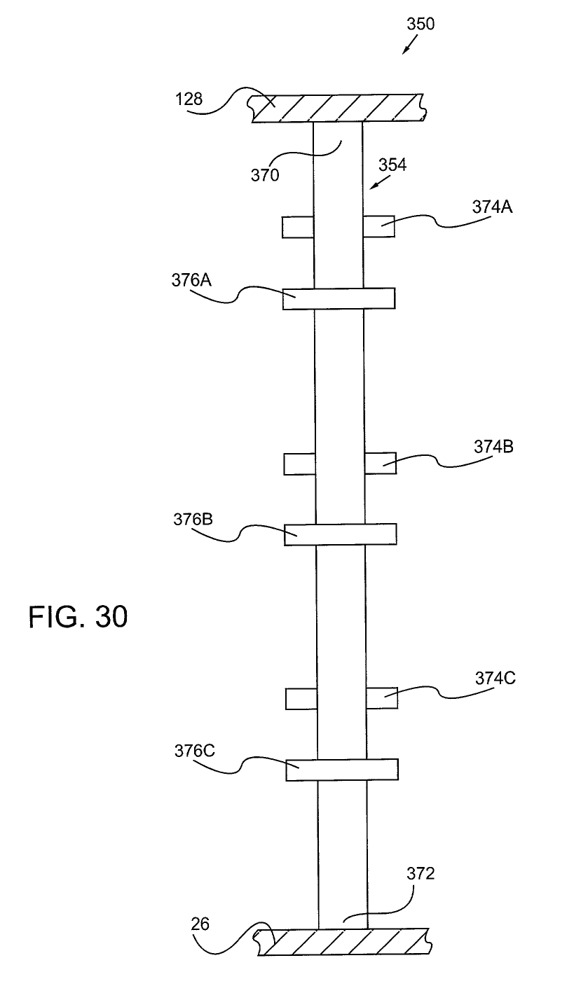

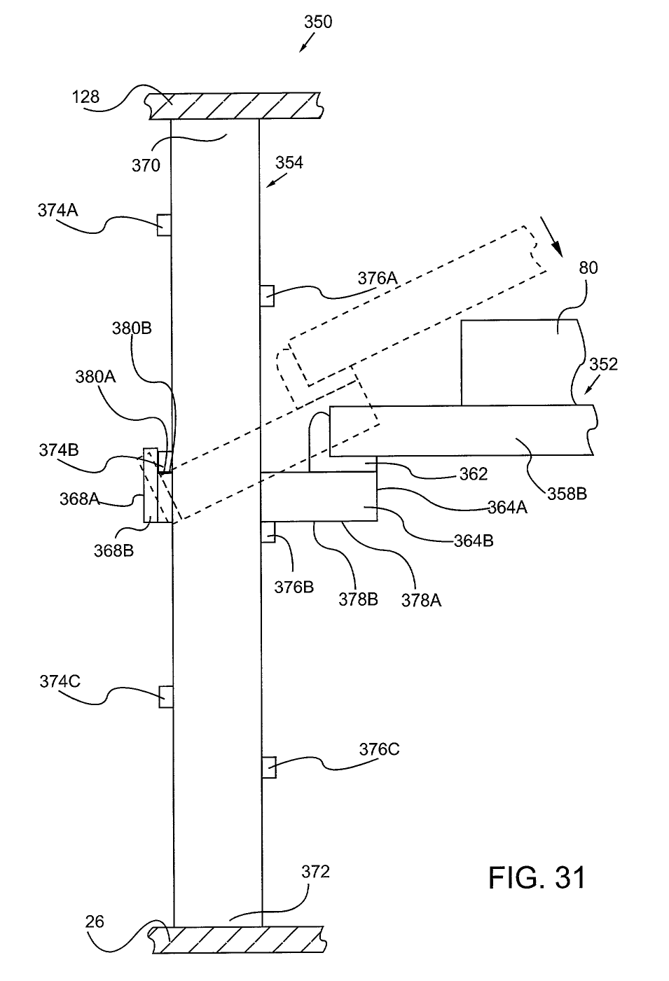

FIGS. 30-32 illustrate the support apparatus 350 attached to the mobile lift 10A. An upper end 370 of the support ladder 354 attaches to an upper portion of the mobile lift 10A such as to the support plate 128 (FIG. 18). The lower end 372 of the support ladder 354 attaches to the main frame 26 of the mobile lift 10A. The support ladder 354 includes a plurality of upper cleats 374A, 374B, and 374C. Additionally, the support ladder 354 includes a plurality of lower cleats 376A, 376B, and 376C. FIG. 31 illustrates a side view of the support apparatus 350. The tray 352 may be removably attached to a selected upper cleat 374 and a selected lower cleat 376. For example, in FIG. 31, the tray 352 is shown engaging with the upper cleat 374B and the lower cleat 376B of the support ladder 354. The tray 352 is shown in a phantom view in a first upward tilted position with the posts 368A and 368B in contact with the upper cleat 374B. Next, the tray 352 is rotated in a clockwise direction to a second position with the lower surfaces 378A and 378B of base elements 364A and 364B, respectively, resting on the cleat 376B. In addition, the upper surfaces 380A and 380B of the base elements 364A and 364B, respectively, rest against the upper cleat 374B. Additionally, the posts 368A and 368B rest against the upper cleat 374B. The tray 352 now lies in a secure horizontal position and may support an object such as the cylinder 80. The tray 352 may be rotated in a counterclockwise direction to release the tray 352 from the support ladder 354. Next, the tray 352 can be lifted and removed from the support ladder 354.

FIG. 32 illustrates the tray 352 being used to support the cylinder 80 being removed from the stationary support apparatus 250. Previously, the operator had to manually lift and lower the cylinder 80 from the elevated rack 252 to the cradles 218 located on the main frame 26 of the mobile lift 10A. The support apparatus 350 of the present invention, however, allows the operator to use the mobile lift 10A to raise and lower the object (e.g., cylinder 80), thus eliminating the manual lifting that was previously required. The operator attaches the tray 352 to the support ladder 354 at a vertical level corresponding to the level of the selected rack 252 in the stationary storage apparatus 250. Next, the operator moves the mobile lift 10A to a position so that the tray 352 is adjacent to the rack 252 of the stationary storage apparatus 250. The operator slides or otherwise displaces the cylinder 80 from the rack 252 onto the tray 352. The operator uses the tong apparatus 22A to grasp and lift the cylinder 80 from the tray 352. The operator then removes the tray 352 from the support ladder 354, and uses the tong apparatus 22 to lower the cylinder 80 onto the cradles 218. The mobile lift 10 is then moved to a selected location for the delivery of the cylinder 80.

An object such as an empty cylinder 80 is delivered to the stationary storage apparatus 250 in the following sequence. Using the tong apparatus 22A, the operator lifts the cylinder 80 from the cradles 218. The operator attaches the tray 352 to the support ladder 354 at a level corresponding to the selected rack 252 level. Then the operator lowers the cylinder onto the tray 352, using the tong apparatus 22A. Next, the operator moves the mobile lift 10A to a position such that the tray 352 is adjacent to the selected rack 252 of the stationary storage apparatus 250. Then the operator slides or otherwise displaces the cylinder 80 onto the rack 252. The operator may then remove the tray 352 from the support ladder 352 and may slide the mobile lift 10A into the stationary storage apparatus as illustrated in FIG. 15.

The foregoing description of the present invention has been presented for purposes of illustration and description. It is not intended to be exhaustive or to limit the invention to the precise form disclosed, and many modifications and variations are possible in light of the above teaching. For example, the mobile lift 10A of the present invention can be used to lift and transport a wide variety of objects such as boxes, mechanical parts, etc. The tong apparatus 22A can be replaced with other load attaching devices (e.g., hooks, grippers, magnets, etc.). The power apparatus 400 may include any suitable means to rotate the winch apparatus 412 (e.g., electric motor, hydraulic motor, internal combustion engine, etc.). Such modifications and variations that may be apparent to a person skilled in the art are intended to be included within the scope of this invention as defined by the accompanying claims.

I claim:

1. A mobile lift comprising:
a main body;
a boom apparatus attached to the main body, wherein the boom apparatus provides rotation of 360 degrees plus an additional rotational angle predetermined by a rotational limiter apparatus; and
an automatic tong apparatus operatively attached to the boom apparatus for automatically engaging and disengaging an object to be lifted.

2. The mobile lift according to claim 1, further including a plurality of wheel assemblies attached to the main body to facilitate movement of the mobile lift across a surface.

3. The mobile lift according to claim 1, further including a main wall attached to the main body for sealing an opening in a stationary storage apparatus.

4. The mobile lift according to claim 1, further including a power apparatus attached to the main body.

5. The mobile lift according to claim 1, wherein the boom apparatus further includes a boom support wheel rolling on a support plate to transfer load from a boom arm to the main body.

6. The mobile lift according to claim 1, wherein the automatic tong apparatus further includes:
a tong main body;
at least two hook arms;
a pivotal attachment for pivotally attaching each hook arm to the tong main body; and
a hook formed on a first end of each hook arm for engaging the object to be lifted.

7. The mobile lift according to claim 6, wherein the automatic tong apparatus further includes a surface formed on a second end of each hook arm for contacting a surface in the tong main body for limiting downward travel of the hook arm.

8. The mobile lift according to claim 1, further including a push handle attached to the main body for moving the mobile lift.

9. The mobile lift according to claim 1, further including a foot brake assembly for selectively holding the mobile lift in a location.

10. The mobile lift according to claim 1, further including a plurality of cradles attached to the main body for securing objects to be lifted.

11. The mobile lift according to claim 1, wherein the object to be lifted is a cylinder.

12. The mobile lift according to claim 3, further including a locking apparatus for securely attaching the main wall of the mobile lift to the stationary storage apparatus.

13. The mobile lift according to claim 3, further including an anchoring apparatus for securing the stationary storage apparatus to a floor surface.

14. The mobile lift according to claim 3, wherein the stationary storage apparatus further includes a plurality of racks for supporting a plurality of objects to be lifted.

15. The mobile lift according to claim 14, wherein the objects to be lifted are cylinders.

16. The mobile lift according to claim 4, wherein the power apparatus comprises:
a motor for rotating a winch apparatus for displacing a cable;
a brake apparatus for selectively holding the cable;
a battery for supplying electrical power to the motor;
a charger for charging the battery; and
a control system for stopping, starting and reversing the direction of the motor.

17. The mobile lift according to claim 16, wherein the control system includes a control module for inputting control signals to the control system.

18. The mobile lift according to claim 17, wherein the control module includes a power switch and a motor direction switch.

19. The mobile lift according to claim 1, wherein the rotational limiter apparatus comprises:
a pivot arm pivotally attached to a support plate of the boom apparatus;
a limit arm attached to the pivot arm for contacting and limiting the rotation of the boom;
a pivot arm support wheel attached to the pivot arm and contacting the support plate of the boom apparatus; and
a resilient member for pulling the limit arm towards a neutral position of the boom apparatus.

20. The mobile lift according to claim 19, wherein the resilient member is an elastic band.

21. The mobile lift according to claim 1, further including a ballast attached to the main body for counteracting the weight of the object being lifted.

22. The mobile lift of claim 1, further including a support apparatus providing support of the object at a level above a main frame of the main body and below the level of the rotatable boom apparatus.

23. The mobile lift of claim 22, wherein the support apparatus includes a support tray removably attached to a support ladder.

24. The mobile lift of claim 23, wherein the support ladder includes a plurality of cleats for providing a plurality of elevational locations for attachment of the support tray.

25. The mobile lift of claim 16, wherein the cable traverses the boom apparatus and wherein a first end of the cable is attached to the automatic tong apparatus and a second end of the cable is attached to the winch apparatus.

26. An apparatus comprising:
a mobile main body, having a cylinder storage device;
a boom apparatus attached to the main body; and
a tong apparatus operatively attached to the boom apparatus for engaging an object to be lifted.

27. The apparatus of claim 26, further including a push handle attached to the mobile main body for moving the mobile main body.

28. The apparatus of claim 26, further including a plurality of cradles attached to the mobile main body for securing objects to be lifted.

29. The apparatus of claim 26, wherein the object to be lifted is a cylinder.

30. The apparatus of a claim 26, further including a plurality of wheel assemblies attached to the mobile main body to facilitate movement of the apparatus across a surface.

31. The apparatus of claim 26, further including a foot brake assembly for selectively holding the mobile main body in a location.

32. The apparatus of claim 26, wherein the boom apparatus provides at least 360 degrees of rotation.

33. The apparatus of claim 26, wherein the tong apparatus automatically engages and disengages from the object.

34. The apparatus of claim 26, further including a support apparatus providing support of the object at a level above a main frame of the main body and below the level of the rotatable boom apparatus.

35. The apparatus of claim 34, wherein the support apparatus includes a support tray removably attached to a support ladder.

36. The apparatus of claim 35, wherein the support ladder includes a plurality of cleats for providing a plurality of elevational locations for attachment of the support tray.

37. The apparatus of claim 26, wherein the boom apparatus provides rotation of 360 degrees plus an additional rotational angle predetermined by a rotational limiter apparatus.

38. The apparatus of claim 37, wherein the rotational limiter apparatus comprises:
a pivot arm pivotally attached to a support plate of the boom apparatus;
a limit arm attached to the pivot arm for contacting and limiting the rotation of the boom;
a pivot arm support wheel attached to the pivot arm and contacting the support plate of the boom apparatus; and
a resilient member for pulling the limit arm towards a neutral position of the boom apparatus.

39. The apparatus of claim 26, wherein the tong apparatus includes:
a tong main body;
at least two hook arms;
a pivotal attachment for pivotally attaching each hook arm to the tong main body; and
a hook formed on a first end of each hook arm for automatically engaging and disengaging the object to be lifted.

40. The apparatus of claim 39, wherein the tong apparatus further includes a surface formed on a second end of each hook arm for contacting a surface in the tong main body for limiting downward travel of the hook arm.

41. A method comprising:
providing a mobile lift including a mobile main body; a boom apparatus attached to the main body; and a tong apparatus operatively attached to the boom apparatus for engaging a cylinder to be lifted;
positioning the tong apparatus proximate the cylinder; and
lowering the tong apparatus and automatically engaging ends of the cylinder with the tong apparatus; and
lifting the cylinder.

42. The method of claim 41, further comprising the step of lowering the tong apparatus and automatically disengaging the cylinder.
